(19) United States
(12) Patent Application Publication
(10) Pub. No.: US 2005/0240527 A1
(43) Pub. Date: Oct. 27, 2005

(54) Combined credit/debit card and associated payment authorization/processing method

(76) Inventor: Daniel Goldman, Germantown, TN (US)

Correspondence Address: LERNER AND GREENBERG, PA, P O BOX 2480, HOLLYWOOD, FL, 33022-2480, US

(21) Appl. No.: 10/832,567

(22) Filed: Apr. 26, 2004

(51) Int. Cl. G06F 17/60

(52) U.S. Cl. 705/44

(57) ABSTRACT

A novel charge card is a combined debit and credit card. The customer is offered an election of a credit feature or of debit feature. If debit is selected, the customer enters a personal identifier (e.g., a PIN). In the further transaction, the novel process investigates the authorization request to determine whether or not a PIN field contains a PIN value or any field or field entry that may indicate that a “personal identification indicator” was entered at the point of sale. If a personal identifier is present, the transaction is authorized against the available balance in the customer's debit (e.g., checking) account. If the PIN is absent, the transaction is authorized against the available credit on a connected line of credit. In an alternative implementation, the customer is offered an election of a credit feature or of debit feature. In both selections, the customer enters a personal identifier. In the further transaction, the novel process investigates the authorization request to determine whether or not the PIN field contains a value indicating that an identifier was entered at the point of sale. If a PIN is present, the payment authorization message is further investigated to determine whether the “Credit” option or “Debit” option was selected. If “Debit” was selected, the transaction is authorized against the available balance in the customer's debit (e.g., checking) account. If “Credit” was selected, or if the PIN is absent, the transaction is authorized against the available credit on a connected line of credit.

### BACKGROUND OF THE INVENTION

1. Field of the Invention

The invention lies in the financial transaction processing field. More specifically, the invention relates to credit and debit transactions, associated data carriers such as simple plastic cards, chip cards, and smart cards, as well as to an associated financial institution communication and transaction clearing system.

2. Description of the Related Art

Card payments are changing the way U.S. consumers purchase goods and services. Consumers now have multiple payment options when purchasing goods and services, with the major types being card, cash or check. We focus here on card payments, which consist of two broad categories: credit (in which consumers “revolve” a line of credit extended by an issuing bank—with the exception of a charge card such as American Express® or Diners Club® that do not allow customers to revolve a balance beyond the contemporaneous period) and debit (in which a purchase transaction amount is directly deducted from a cardholder's bank deposit account).

Within debit, there are signature-based and PIN-based forms of payment. Signature-based debit transactions are processed (or “switched”—switching is the process by which a card transaction is settled between the bank issuing the card and the bank accepting the card for payment on behalf of a merchant) through the Visa® or MasterCard® networks used to process credit card transactions. A customer initiates the payment by signing a purchase slip at a point of sale. These are sometimes referred to as “offline” debit transactions, and branded as Visa® Check Card and MasterCard® Money. PIN-based debit transactions are switched over the EFT (electronic funds transfer) networks also used to switch ATM transactions. Customers initiate a payment by keying their personal identification number (“PIN”) into a PIN pad at point of sale. These are sometimes referred to as “online” debit transactions and branded under marks such as STAR® (owned by FDR). Both transaction methods are still debit transactions, as the amount of the purchase is deducted from the customer's debit account, such as a bank checking account.

The “switching” of signature debit and credit card transactions over networks is essentially identical; the difference arises with issuer processing, since a debit transaction hits a customer's checking account while a credit transaction hits a pre-approved line of credit. The EFT networks were originally developed to allow ATM transactions to be switched between banks—so that customers could use ATM cards issued by Bank A at ATM terminals operated by Bank B, for example. However, they have extended their reach into the debit arena by placing PIN pads at merchant “point-of-sale” with connections to the merchant cash register.

Debit Card payment authorization requests originate from a merchant terminal. The merchant terminal is programmed to accommodate specified credit and/or debit issuers. A BIN (BIN=bank identification number), a distinct 4 to 6-digit number (assigned by Visa/MasterCard that identifies an issuer) identifies accepted card types.

A customer's card is swiped through a merchant terminal. If a PIN pad is present, the customer may be prompted to select a “Debit” or “Credit” option. Typically, a Service Code assignment on the card's magnetic stripe directs the terminal to prompt the customer to enter a PIN if the “Debit” option is selected.

The merchant's terminal transmits a transaction message, including a pre-assigned code identifying the customer's preference to complete the transaction as a “Debit” transaction or a “Credit” transaction, to the merchant's processor. The merchant's processor investigates the transaction message for a “Debit” or “Credit” transaction type designation and routes the authorization request accordingly.

Transactions flow from the merchant's processor through Visa/MasterCard or regional networks to the issuer's processor and finally to the issuer. The issuer identifies the transaction type designation as “Debit” or “Credit” (if “Debit, ” the issuer investigates the authorization request for the personal identification number collected at the merchant's terminal) and approves or declines the transaction (based on available balance in the connected debit account) and sends the authorization dispositions back through the same channels and touch points.

Transactions initiated with a debit card, regardless of whether the customer selects the “Debit” option or “Credit” option, always deduct the amount of the purchase from the available balance in the connected debit account (e.g., demand deposit account, stored value or prepaid account).

A variety of multi-purpose cards have been proposed in the prior art. For example, U.S. Pat. No. 6,631,849 B2 to Blossom describes a smart card that enables the customer to select any of a number of features. Several magnetic stripes are available for swiping so as a trigger any of the various features. A further smart card is disclosed in U.S. Pat. No. 6,609,654 B1 to Anderson et al. There, the user can customize the card by first selecting one of the features, and then programming the card in a card number generator. Another multifunction card is described in U.S. Pat. No. 6,000,608 to Dorf. There, a single card can function as a credit card, a debit card, a phone card, a loyalty card, and the like. The considerable variety of features is associated with relatively complicated handling of the card, that is, while the scope of functionality of the card is very impressive, it may not be simple enough to allow average consumers to utilize the card without complications in everyday use. Also, most of the prior art smart cards require different terminals from the ones currently present at most points of sale and the prior art systems can therefore not be easily introduced.

Newer generations of smart cards, such as the multiple application cards described in U.S. Pat. Nos. 5,578,808 and 6,631,849, allow many different accounts and transactions to be accessed by the customer. The simplicity of a dual-function card that automatically processes the transaction as a debit transaction or as a credit transaction, with a simple selection on the user's side, cannot be obtained with the more complicated multiple application cards, such as smart cards.

In a realistic current environment, the customer carries a card for credit transactions and a separate card for debit transactions. Or, in the case of the combined multi-functional cards of the prior art, the selections are simply too complicated for mass application and they are effectively too transparent in the context of everyday credit/debit transactions.

### SUMMARY OF THE INVENTION

It is accordingly an object of the invention to provide a combined credit/debit card and associated payment authorization/processing method, which overcomes the above-mentioned disadvantages of the heretofore-known devices and methods of this general type and which provides for a single card that functions as both a debit card and a credit card, and which further offers the consumer a simple choice at the POS to utilize credit or debit functionality.

With the foregoing and other objects in view there is provided, in accordance with the invention, a payment authorization method, which comprises:

gathering, at a merchant's, account information for payment of a customer's purchase;

prompting the customer to select a debit purchase option or a credit purchase option and, if the debit purchase option is selected, prompting for an entry of a personal identifier relating to the customer;

transmitting an authorization request to a financial authorization system requesting payment authorization for the customer's purchase, the authorization request including the account information, and if the debit purchase option is selected, the personal identifier;

checking whether or not the authorization request includes the personal identifier, and:

if the authorization request includes the personal identifier, processing the purchase as a debit purchase; and

if the authorization request does not include the personal identifier, processing the purchase as a credit purchase.

In accordance with an added feature of the invention, the gathering step comprises swiping a card presented by the customer and containing the account information.

With the above and other objects in view there is also provided, in accordance with a second embodiment of the invention, a payment authorization method, which comprises:

gathering, at a merchant's, account information for payment of a customer's purchase;

prompting the customer to select a debit purchase option or a credit purchase option and prompting for an entry of a personal identifier relating to the customer;

transmitting an authorization request to a financial authorization system requesting payment authorization for the customer's purchase, the authorization request including the account information and the personal identifier;

checking whether the debit purchase option or the credit purchase option has been selected at the merchant's; and

processing the purchase as a debit purchase or a credit purchase in dependence on the option chosen at the merchant's.

With the above and other objects in view there is also provided, in accordance with the invention, a computer-readable medium having stored thereon a data structure, comprising:

a first field containing data representing authorization to effect an online debit transaction;

a second field containing data representing authorization to effect a credit transaction; and

a third field containing data for offering a user to select the debit transaction or the credit transaction.

In accordance with again another feature of the invention, the computer-readable medium is a combined debit and credit card for use in an associated financial transaction system. Preferably, the information is contained on a magnetic stripe (magstripe), storage medium or chip on a plastic card. The plastic card has one of the standard credit or debit card dimensions.

In summary, transaction authorization requests originate from a merchant terminal. The merchant terminal is programmed to accommodate specified credit and/or debit issuers. Accepted card types are identified by BINs (BIN=bank identification number, a unique 4 to 6-digit number, assigned by Visa/MasterCard, that identifies an issuer, card type, and card program). Transactions flow from the terminal driver through the Visa/MasterCard network to the issuer processor and finally to the issuer. The issuer approves or declines the transaction and sends the authorization disposition back through the same channels and touch points.

In one of the embodiments provided here, an authorization request from a merchant is investigated to determine the presence of any PIN value or any field or field entry that may indicate that a PIN or any “personal identification indicator” was entered at the point of sale. If it is determined that a PIN was present, the transaction is authorized against the available balance in the customer's connected checking account or a similar cash account. If the presence of a PIN or any “personal identification indicator” is absent, the transaction will be authorized against the available credit on a connected line of credit (proprietary or agent).

In accordance with an alternative implementation of the invention the customer is required to enter their PIN or, more generally, their personal identifier, regardless of the transaction type (credit or debit) selected. In this implementation, the customer still selects the “credit” or “debit” option according to their purchasing preference. The related service code encoded on the magstripe specifies the PIN prompt requirement.

The novel process investigates the authorization request to determine the presence of any PIN value or any field or field entry that may indicate that a PIN or any “personal identification indicator” was entered at the POS (point of sale). If it is determined that a PIN was present, it is further determined whether the “Credit” option or “Debit” option was selected. If the “Debit” option is selected, the transaction is authorized against the available balance in the customer's connected debit (e.g., checking, stored value, or prepaid account) account. If the “Credit” option is selected or the presence of a PIN or any “personal identification indicator” is absent, the transaction will be authorized against the available credit on a connected line of credit.

The novel dual-function card, in combination with the associated payment authorization/processing method, thus provides for real-time single card access to a proprietary or agent line of credit as well as a debit account. The use of the card is simple and its dual functionality is transparent. The additionally necessary authorization and transaction process, on the other hand, is entirely non-transparent to the user. The only choice to the customer is to select whether the transaction is supposed to be processed as a credit transaction or as a real-time debit transaction.

Other features which are considered as characteristic for the invention are set forth in the appended claims.

Although the invention is illustrated and described herein as embodied in a combined credit/debit card and associated payment authorization/processing method, it is nevertheless not intended to be limited to the details shown, since various modifications and structural changes may be made therein without departing from the spirit of the invention and within the scope and range of equivalents of the claims.

The construction of the invention, however, together with additional objects and advantages thereof will be best understood from the following description of the specific embodiment when read in connection with the accompanying drawings.

### BRIEF DESCRIPTION OF THE DRAWING

FIG. 1 is a schematic diagram illustrating a transaction according to the invention, in which the customer carrying the combined credit/debit card selects the debit or credit option and the transaction is automatically processed;

FIG. 2 is a diagram illustrating an exemplary data structure according to the invention;

FIG. 3A is a flow diagram of a first implementation in which a personal identifier is required at the point of sale only if the debit option is selected; and

FIG. 3B is a flow diagram of a second implementation of the invention, in which a personal identifier is entered for debit and for credit transactions.

### DESCRIPTION OF THE PREFERRED EMBODIMENTS

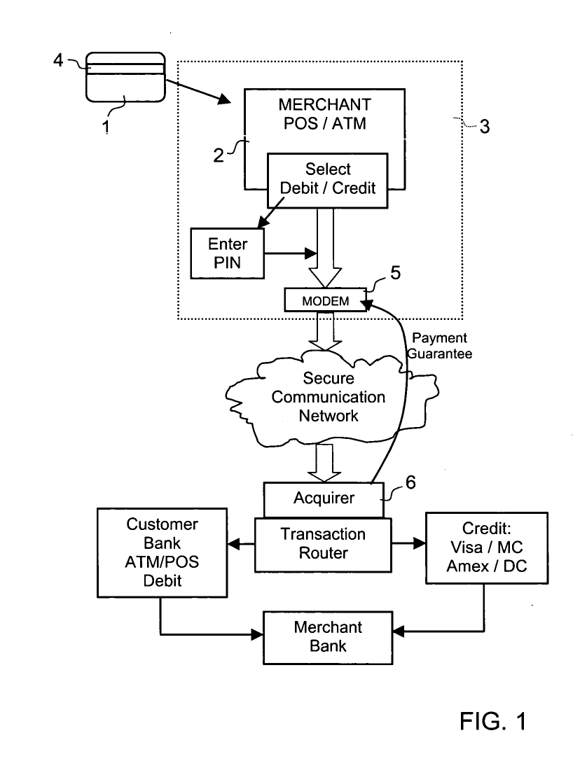

Referring now to the figures of the drawing in detail and first, particularly, to FIG. 1 thereof, there is seen a simplified process stream in a cash-less sales transaction. A charge card 1 is swiped at a magnetic card reader 2 at a merchant terminal 3, or the card number is manually entered at the merchant terminal 3. The latter may represent a store, it may be a teller or an automated teller machine (ATM), or it may be a virtual terminal in an internet-type transaction. The card holder is now prompted and selects a debit transaction or a credit transaction on the merchant terminal 3. If debit is selected, the cardholder enters the PIN associated with the card or with the account. If credit is selected, the cardholder is requested to sign for the purchase.

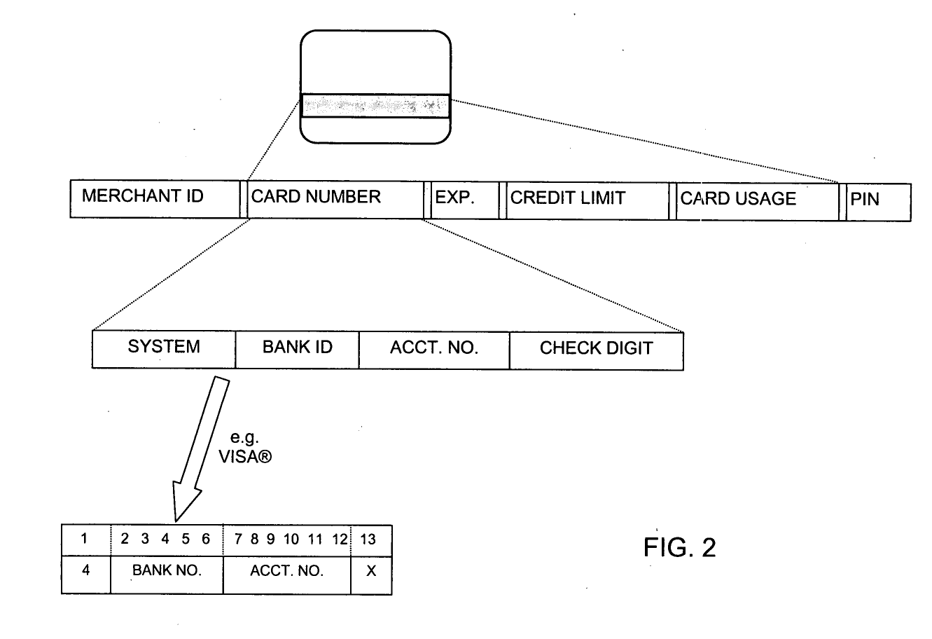

If the card is swiped—as in the majority of transactions—the information on the magnetic stripe on the back of the credit card 4 (also referred to as a magstripe) is read. Reference is had to FIG. 2. The magnetic stripe contains information in accordance with the ISO/IEC standard 7811. In fact, the stripe is typically formed of three tracks with differently formatted information. In order not to unnecessarily complicate this description, only a single line stripe will be described. Besides some start and checksum characters that ensure the proper reading of the information, and also some optional information, the stripe contains the card number, a country identifier, service code, and the expiration date of the card.

The numbering system used by most credit/debit card systems follows ANSI Standard X4.13-1983. According to the standard, the first digit defines the particular system to which the card belongs. For example, the leading digit “3” identifies the card as a travel/entertainment card (e.g., American Express®—starting with “37”, Diners Club®—starting with “38”). The digit “4” pertains to Visa®, the digit “5” pertains to MasterCard®, and the digit “6” pertains to Discover Card®. The digits following the system leader signify a variety of information items, including the bank number and the account number.

As shown in the lowermost box in FIG. 2, which illustrates a Visa® system number, the system “4” is placed as the first digit. Digits 2-6 are the bank number. Digits 7-12 are the account number. For a 13-digit card, digit 13 is a checksum digit, the calculation of which enables a quick check if the card was read and/or transmitted correctly. Many cards are 15 or 16 digits. The Mastercard® numbering is quite similar, except that the account number is two digits longer, so that the checksum digit falls to the digit position 15. Specifics are known to those of skill in the art and further description is therefore not necessary.

The first data line illustrated in FIG. 2 shows an exemplary placement of the swiped information within the data transfer from the merchant's POS to the authentication system. As shown, the data stream includes a merchant ID and a position for a personal identifier, such as a PIN.

In the alternative embodiment, in which the customer is prompted for a PIN or similar identifier even if the transaction is to be routed as a credit transaction, the system will receive a PIN either way. Accordingly, there has to be effected a preliminary query with regard to the selected transaction. The preliminary query is shown in phantom—indicating an option—in FIG. 2 preceding the above-described automatic PIN query according to the invention.

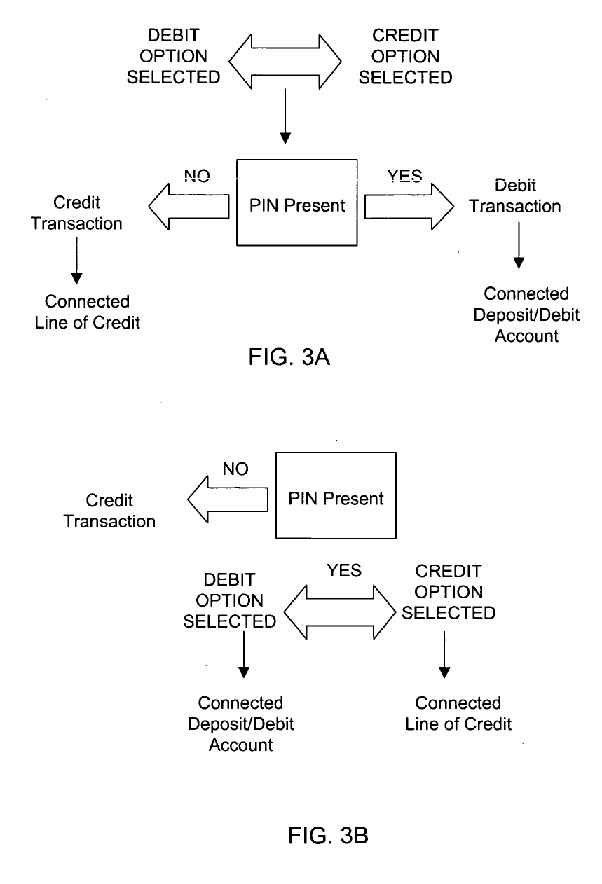

The first alternative, in which the PIN is required at the point of sale only when the debit option is selected, is shown in FIG. 3A. The double arrow at the top thus pertains to the front end of the transaction, namely the point of sale, where the customer is offered the debit/credit choice. In some cases, this choice is already satisfied where the POS terminal does not even prompt for a PIN or the customer simply elects to “swipe” without entering an ID or PIN. In that case, because not PIN is detected at the back end (the processor), the transaction is processed as a credit transaction.

The second alternative, in which the PIN is required in either case, i.e., when debit or credit is selected at the POS, is illustrated in FIG. 3B. Here, the double arrow appears at the back end and the decision regarding the debit/credit processing is effected based on another item of information. That is, the process flow is not defined by the presence or the absence of a PIN in and of itself, but instead on another datum that indicates the consumer's choice to the back end.

The transaction, of course, is rejected, if the issuing bank reports insufficient funds. In the alternative, the customer's debit/credit agreement with her specific issuer may also stipulate for a diversion. That is, if the checking account balance is insufficient to cover the requested transaction, the system may automatically rerout the transaction into the credit system. This would protect the cardholder against a possibly embarrassing situation of having to deal with a rejected transaction request at the point of sale. If the credit limit has been reached as well (i.e., card account is “maxed out”), then there may be no alternative than for the acquirer 6 to inform the merchant 3 that the transaction has not been authorized.

1. A payment authorization method, which comprises:
gathering, at a merchant's, account information for payment of a customer's purchase;
prompting the customer to select a debit purchase option or a credit purchase option and, if the debit purchase option is selected, prompting for an entry of a personal identifier relating to the customer;
transmitting an authorization request to a financial authorization system requesting payment authorization for the customer's purchase, the authorization request including the account information, and if the debit purchase option is selected, the personal identifier;
checking whether or not the authorization request includes the personal identifier, and:
if the authorization request includes the personal identifier, processing the purchase as a debit purchase; and
if the authorization request does not include the personal identifier, processing the purchase as a credit purchase.

2. The method according to claim 1, wherein the gathering step comprises swiping a card presented by the customer and containing the account information.

3. A payment authorization method, which comprises:
gathering, at a merchant's, account information for payment of a customer's purchase;
prompting the customer to select a debit purchase option or a credit purchase option and prompting for an entry of a personal identifier relating to the customer;
transmitting an authorization request to a financial authorization system requesting payment authorization for the customer's purchase, the authorization request including the account information and the personal identifier;
checking whether the debit purchase option or the credit purchase option has been selected at the merchant's; and
processing the purchase as a debit purchase or a credit purchase in dependence on the option chosen at the merchant's.

4. The method according to claim 3, wherein the gathering step comprises swiping a card presented by the customer and containing the account information.

5. The method according to claim 3, which comprises processing the purchase as a credit purchase if the authorization request does not include the personal identifier.

6. A computer-readable medium having stored thereon a data structure, comprising:
a first field containing data representing enablement to effect an online debit transaction;
a second field containing data representing enablement to effect a credit transaction; and
a third field containing data for offering a user to select the debit transaction or the credit transaction.

7. The computer-readable medium according to claim 6 configured as a combined debit and credit card for use in an associated financial transaction system.

8. The computer-readable medium according to claim 7, wherein said first, second, and third fields are contained in a storage medium such as a magnetic stripe on a plastic card.
